(19) United States
(12) Patent Application Publication
(10) Pub. No.: US 2009/0327535 A1
(43) Pub. Date: Dec. 31, 2009

(54) ADJUSTABLE READ LATENCY FOR MEMORY DEVICE IN PAGE-MODE ACCESS

(76) Inventor: Tz-yi Liu, Palo Alto, CA (US)

Correspondence Address: VIERRA MAGEN/SANDISK CORPORATION, 575 MARKET STREET, SUITE 2500, SAN FRANCISCO, CA, 94105, US

(21) Appl. No.: 12/164,601

(22) Filed: Jun. 30, 2008

(51) Int. Cl. G06F 3/00

(52) U.S. Cl. 710/52; 710/60

(57) ABSTRACT

A read process in a memory device is optimized. Sub-pages of a page of data are read from storage elements by an internal controller of the memory device at a read speed of the internal controller. At a specific time, the controller sets a READY signal to inform an external host to start reading out data from the buffer in a continuous burst, at the associated read speed of the host, which can differ from the controller's read speed, and asynchronous to the internal controller. The READY signal is set so that the host can complete its burst before the buffer runs out of data, while overall read time is minimized. The controller can also be configured for use with hosts having different read speeds. A host may communicate an identifier to the controller for use in determining an optimum time to set the READY signal.

### BACKGROUND OF THE INVENTION

1. Field of the Invention

The present invention relates to a memory device.

2. Description of the Related Art

Semiconductor memory has become increasingly popular for use in various electronic devices. For example, non-volatile semiconductor memory is used in cellular telephones, digital cameras, personal digital assistants (PDAs), mobile computing devices, non-mobile computing devices and other devices. Electrically Erasable Programmable Read Only Memory (EEPROM) and flash memory are among the most popular non-volatile semiconductor memories. Flash memory includes NAND and NOR types. Other popular types of memory include Dynamic Random Access Memory (DRAM), among others. DRAM is a type of random access memory that stores each bit of data in a separate capacitor within an integrated circuit. Memory devices store data in a programming or writing process. The data can be subsequently read in a read process. Typically, a charge level in a storage element is associated with one or more bits of data.

Moreover, for both the traditional EEPROM and the flash memory utilize a floating gate that is positioned above and insulated from a channel region in a semiconductor substrate. The floating gate is positioned between source and drain regions. A control gate is provided over and insulated from the floating gate. The threshold voltage of the transistor thus formed is controlled by the amount of charge that is retained on the floating gate. That is, the minimum amount of voltage that must be applied to the control gate before the transistor is turned on to permit conduction between its source and drain is controlled by the level of charge on the floating gate. Binary memory devices store one bit of data per storage element, while multi-state (also called multi-level) memory devices store two or more bits of data.

A read operation typically involves applying one or more control gate read voltages to the storage elements, such as via a word line or other control line which is in communication with the storage elements which are being read, and sensing, for each read voltage, whether the storage elements are conductive, via associated bit lines and sense amplifiers. The states of the storage elements can then be translated to digital data. During a read operation, a read command may be received by a controller, such as from an external host, which desires to access the stored data. To optimize performance, it is necessary to quickly read the data in the memory device and make it available in a buffer for access by the external host. However, significant delays can result when there is a mismatch between the internal read speed and the read speed of the external host.

### SUMMARY OF THE INVENTION

The present invention provides a method for minimizing latency time in a memory device during a read operation.

In one embodiment, a method for operating a memory device includes, in response to a read command from an external host, successively reading portions of a set of storage elements, one portion at a time, and storing data from each portion in a buffer. The method further includes determining when the buffer is ready to be read by the external host based on at least one criterion, and when the buffer is ready to be read based on the determining, informing the external host that the buffer is ready to be read, in response to which the external host starts reading the buffer in a burst, asynchronous to the storing of data from each portion in the buffer, and finishes reading the buffer no sooner than when the storing of data from each portion in the buffer is completed.

In another embodiment, a method for operating a memory device includes receiving a read command from an external host, in response to the read command, successively reading portions of a set of storage elements, one portion at a time, and storing data from each portion in a buffer, receiving data from the external host, and determining when the buffer is ready to be read by the external host based on the data. When the buffer is ready to be read based on the determining, the method further includes informing the external host that the buffer is ready to be read.

In another embodiment, a method for operating a memory device includes determining a criterion by which the memory device signals an external host to begin continuously reading data from a buffer in the memory device, such that the external host finishes reading the buffer no sooner than when a page of data is completely stored in the buffer from storage elements of the memory device. The page of data is stored in the buffer one sub-page at a time, asynchronous with, and at a slower rate than, the reading of the data from the buffer by the external host. The method further includes configuring the memory device with the criterion.

In another embodiment, a memory device includes a set of storage elements, a buffer and at least one control circuit in communication with the set of storage elements and the buffer. The at least one control circuit: (a) in response to a read command from an external host, successively reads portions of the set of storage elements, one portion at a time, and stores data from each portion in the buffer, (b) determines when the buffer is ready to be read by the external host based on at least one criterion, and (c) when the buffer is determined to be ready, informs the external host that the buffer is ready to be read, in response to which the external host starts reading the buffer in a burst, asynchronous to the storing of data from each portion in the buffer, and finishes reading the buffer no sooner than when the storing of data from each portion in the buffer is completed.

Corresponding methods, systems and computer- or processor-readable storage devices for performing the methods provided herein may be provided.

### BRIEF DESCRIPTION OF THE DRAWINGS

FIG. 1 depicts a set of storage elements and sense amps.

FIG. 2 depicts a set of storage elements and multiplexed sense amps.

FIG. 3 depicts a block diagram of an array of storage elements.

FIG. 4a depicts timing of controller and host read operations, where the controller and host have the same read speed.

FIG. 4b depicts timing of controller and host read operations, where the controller has a faster read speed than the host.

FIG. 4c depicts timing of controller and host read operations, where the host has a faster read speed than the controller.

FIG. 5a depicts timing of controller and host read operations of page columns, where the controller and host have the same read speed.

FIG. 5b depicts timing of controller and host read operations of page columns, where the controller has a faster read speed than the host.

FIG. 5c depicts timing of controller and host read operations of page columns, where the host has a faster read speed than the controller.

FIG. 6 depicts a process for configuring a memory device for read operations with a host.

FIG. 7 depicts a process for configuring a memory device for read operations with multiple hosts.

FIG. 8 depicts a read operation.

FIG. 9 depicts an overview of a host controller and a memory device.

FIG. 10 depicts a block diagram of a non-volatile memory system using single row/column decoders and read/write circuits.

### DETAILED DESCRIPTION

The present invention provides a method for minimizing latency time in a memory device during a read operation.

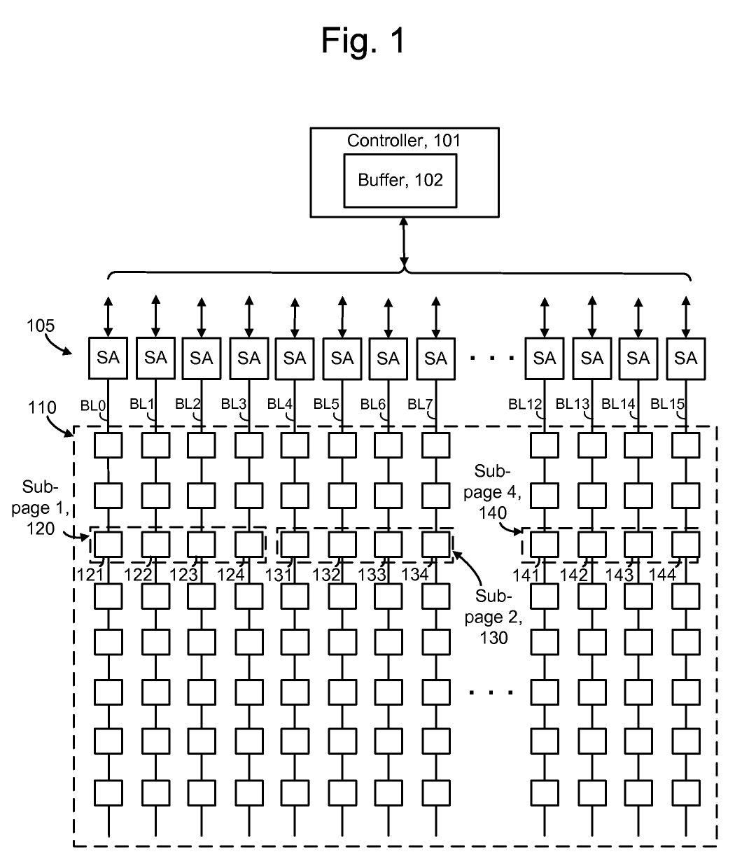

FIG. 1 depicts a set of storage elements and sense amps. A set of storage elements 110 includes a number of storage elements arranged in columns, where each column is coupled to a sense amplifier (SA) in a set of sense amps 105 via a respective bit line (BL0-BL15). The sense amplifiers communicate with a controller 101 and buffer 102 of the memory device. For example, each column of storage elements may be connected in series. The storage elements or memory cells may include non-volatile memory (including NAND and NOR flash memory) or volatile memory (including DRAM). In another approach, each column has only one storage element. Control lines such as word lines (not shown) may communicate with each row of storage elements, such as to provide a control gate voltage to the storage elements which are selected for a read operation. Further, memory devices having one or more physical device levels, including 3d monolithic devices, may be used.

During a read process, a host controller (host) which is external to a memory device on which the storage elements are formed may provide a read command to the internal controller (controller) 101 of the memory device. For example, in a digital camera application, the memory device may be provided on a card which is inserted into the camera, while a host of the camera accesses the memory card to read and write data. The read command informs the controller of one or more pages of data which are desired to be read. A page is typically the smallest amount of data which can be read in a read command of the host operating on a page basis. This can be, e.g., a few bytes or a few hundred bytes. During a read operation, a page of data may be read in portions, e.g., sub-pages, and stored in the local buffer 102 of the memory device for read out by the host. The controller of the memory device does not always read a whole page, even though the memory device produces a page of data. Each page read command carried out by the controller may only result in, at most, one page worth of data available for the host. In a burst read approach which can improve throughput, the host reads the buffer 102 in a continuous burst while the controller successively reads different groups of the storage elements which store the corresponding sub-pages.

Thus, a page can be considered to be made up of a number of sub-pages. Further, each sub-page can have the same amount of data, or the sub-pages can have different amounts of data. In the simplified example of FIG. 1, each sub-page includes an amount of data which can be stored by four storage elements. For example, for four-level (2-bit) storage elements, a sub-page of four of such elements will include eight bits or one byte of data. Here, sub-page 1 (120) includes the data from storage elements 121-124, sub-page 2 (130) includes the data from storage elements 131-134 and sub-page 3 (140) includes the data from storage elements 141-144. During the read operation, the controller 101 may read sub-page 1 (120), then sub-page 2 (130), then sub-page 3 (not shown) and then sub-page 4 (140). Each read process involves ascertaining the state of the storage elements and storing corresponding data in the buffer 102. The read process may include various decoding processes as well. For instance, the data may be stored using an error correction code (ECC) coding process or redundancy coding which creates some redundant bits, in which case corresponding decoding processes are performed during the read to obtain the corrected data.

Note that the storage elements which are read can be adjacent and/or non-adjacent. For example, in an all bit line approach, the storage elements of adjacent bit lines are read, while in an odd-even approach, the storage elements of the odd bit lines are read separately from the storage elements of the even bit lines.

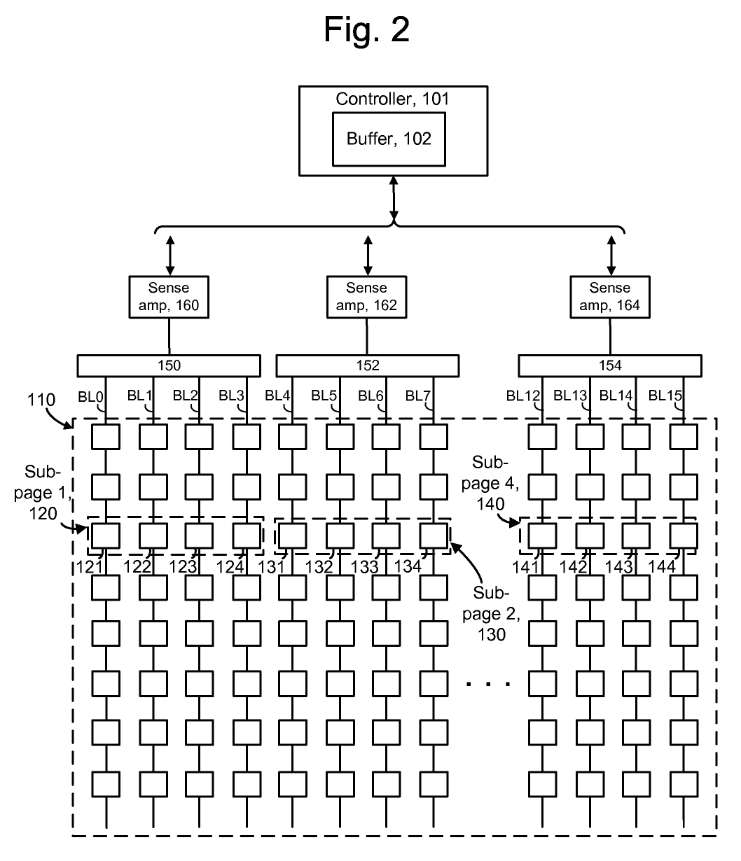

FIG. 2 depicts a set of storage elements and multiplexed sense amps. In some case, a sense amp is shared by more than one column of storage elements in order to provide a more compact design. For example, a sense amp 160 may be shared by the storage elements associated with BL0-BL3 via multiplexer 150, a sense amp 162 may be shared by the storage elements associated with BL4-BL7 via multiplexer 152, a sense amp (not shown) may be shared by the storage elements associated with BL8-BL11 (not shown) via an associated multiplexer (not shown), and a sense amp 164 may be shared by the storage elements associated with BL12-BL15 via multiplexer 154. During a read operation, the controller 101 may read one storage element from each sub-page.

For example, the controller 101 may read storage element 121 via multiplexer 150 and sense amp 160, while also reading storage element 131 via multiplexer 152 and sense amp 162, a first storage element in sub-page 3 (not shown) via an associated multiplexer and sense amp, and storage element 141 via multiplexer 154 and sense amp 164. Subsequently, the controller may read storage element 122 via multiplexer 150 and sense amp 160, while also reading storage element 132 via multiplexer 152 and sense amp 162, a second storage element in sub-page 3 (not shown) via an associated multiplexer and sense amp, and storage element 142 via multiplexer 154 and sense amp 164. Subsequently, the controller may read storage element 123 via multiplexer 150 and sense amp 160, while also reading storage element 133 via multiplexer 152 and sense amp 162, a third storage element in sub-page 3 (not shown) via an associated multiplexer and sense amp, and storage element 143 via multiplexer 154 and sense amp 164. Subsequently, the controller may read storage element 124 via multiplexer 150 and sense amp 160, while also reading storage element 134 via multiplexer 152 and sense amp 162, a fourth storage element in sub-page 3 (not shown) via an associated multiplexer and sense amp, and storage element 144 via multiplexer 154 and sense amp 164.

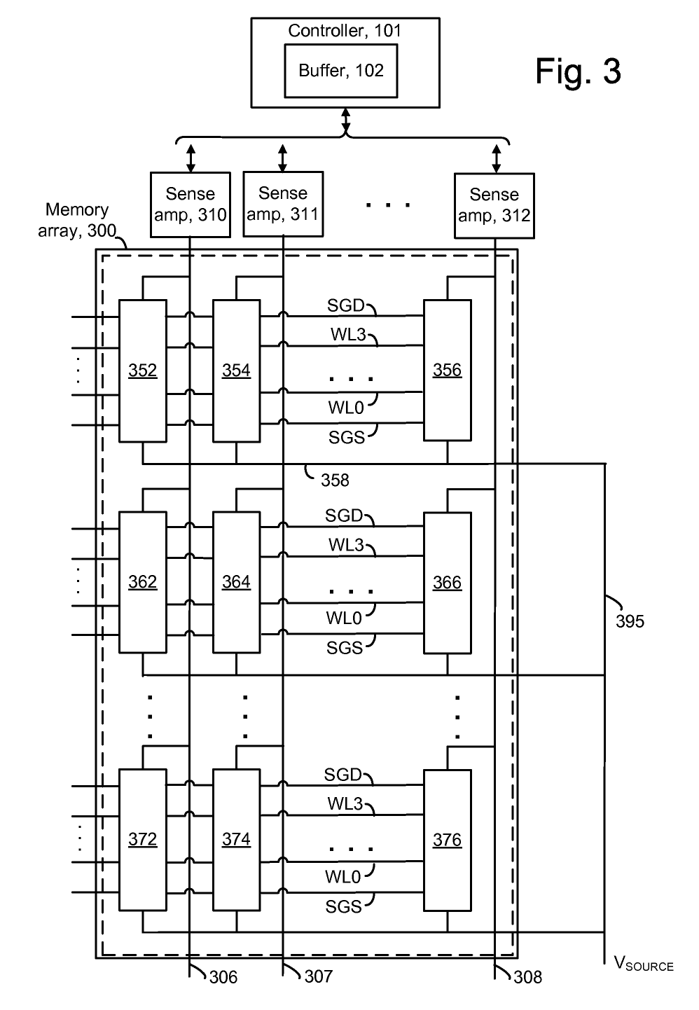

FIG. 3 depicts a block diagram of an array of storage elements, including different sets of storage elements which communicate with a common sense amp. In a memory array 300, a number of sets of memory elements are provided, including sets 352, 362 and 372 which communicate with a sense amp 310 via a bit line 306, sets 354, 364 and 374 which communicate with a sense amp 311 via a bit line 307, and sets 356, 366 and 376 which communicate with a sense amp 312 via a bit line 308. Each set may also communicate with a source line 395. In one possible approach, each set of storage elements is a NOR string. WL0 through WL3 denote word lines, SGS denotes a select gate (source) line, and SGD denotes a select gate (drain) line. Appropriate read voltages are applied to the word lines during a read operation. The selected word line receives a control gate read voltage while the unselected word lines receive a read pass voltage which is typically higher.

In one approach, the memory array is formed on a substrate which employs a triple-well technology which includes a p-well region within an n-well region, which in turn is within a p-type substrate region. The NOR strings can be formed, at least in part, on the p-well region.

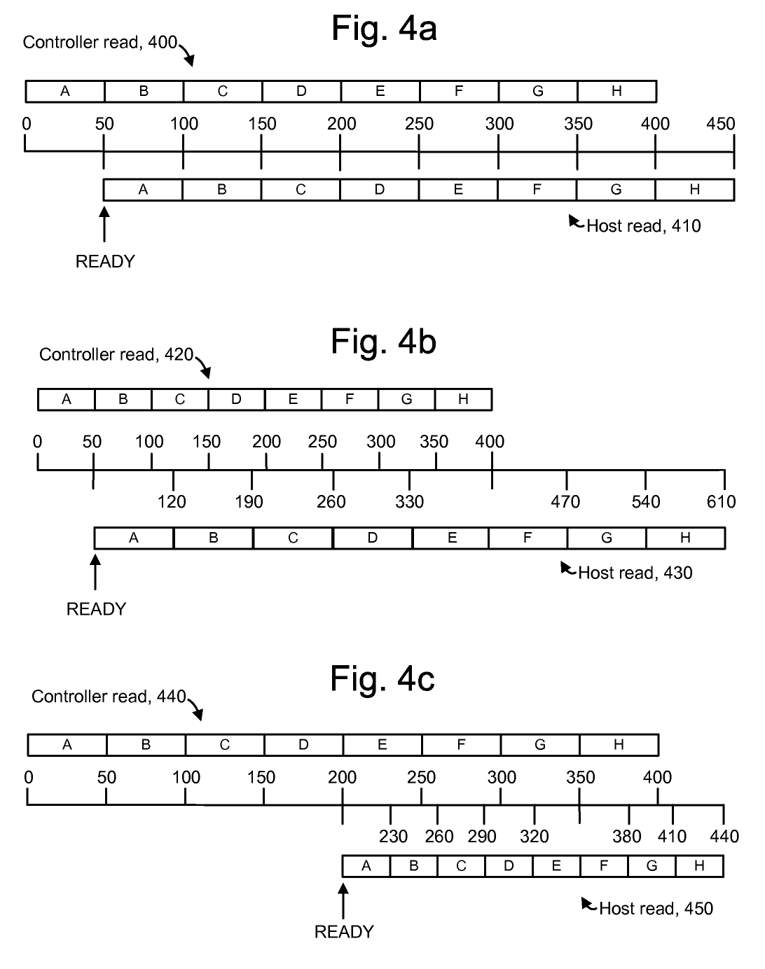

FIG. 4a depicts timing of controller and host read operations, where the controller and host have the same read speed, e.g., 50 ns. As mentioned at the outset, during a read operation, a read command may be received by a controller, such as from an external host, which desires to access the stored data. To optimize performance, it is necessary to quickly read the data in the memory device and make it available in a buffer for access by the external host. However, significant delays result when there is a mismatch between the internal read speed and the read speed of the external host.

In some cases, the host and the internal controller of the memory device have the same read speed. An example read speed is 30-50 ns per cycle. As mentioned, sub-pages of data are read by the controller and stored in a local volatile memory such as a buffer for read out by the host. Further, when the host reads in a burst mode, there should be sufficient data in the buffer so that the host can read the buffer continuously until it has read all the data of a requested page. To achieve this, the controller performs a pre-read so that some initial amount of data is stored in the buffer when the host begins reading. The host begins reading the buffer in response to a READY/BUSY signal which is set to READY by the controller. When the controller and the host have the same read speed, it is sufficient for the controller to pre-read one sub-page of data before setting the READY signal.

FIG. 4a depicts a time line, e.g., in units of nanoseconds (ns), data portions 400 labeled A, B, C, D, E, F, G and H which represent sub-pages of data which are read by the internal controller of the memory device, and corresponding data portions 410 which are read by the host. As an example, a page has eight bytes of data, each sub-page has one byte of data and the controller and host have the same read cycle time, e.g., 50 ns per byte. At 0-50 ns on the time line, sub-page A is pre-read by the controller and stored in the buffer. Thus, one complete sub-page is available in the buffer. The sub-page portion depicted is considered to the smallest unit of data which is read by the controller. Note that in this and other examples, the sub-pages which are read by the controller are equal in size. Similarly, the sub-pages which are read from the buffer by the host are equal in size. However, this is not necessary, as different sized sub-pages can be read by the controller and stored in the buffer, and different sized sub-pages can be read from the buffer by the host. For example, sub-pages of one, two and three bytes can be read by the controller. The sub-page size or sizes used by the host can be different from that of the controller.

At 50 ns, the controller sets the READY signal so that the host begins reading, namely reading sub-page portion A. This denotes a read latency of 50 ns. While the host reads portion A from the buffer, the controller reads portion B. The process proceeds accordingly until the controller has completed reading portion H at 400 ns at which time the host begins reading portion H. Thus, at 100 ns, the controller has completed reading, and the host begins reading, portion B. At 150 ns, the controller has completed reading, and the host begins reading, portion C. At 200 ns, the controller has completed reading, and the host begins reading, portion D. At 250 ns, the controller has completed reading, and the host begins reading, portion E. At 300 ns, the controller has completed reading, and the host begins reading, portion F. At 350 ns, the controller has completed reading, and the host begins reading, portion G. At 400 ns, the controller has completed reading, and the host begins reading, portion H. The read process is completed at 450 ns once the host finishes reading portion H.

In this and the other examples, the READY signal is set based on the competing goals of the host reading continuously and completing the read process in as short a time period as possible (which involves minimizing the amount of pre-read data). In the case of FIG. 4a, the read latency is 50 ns rather than 400 ns which would be incurred if the entire page were to be read before setting the READY signal.

FIG. 4b depicts timing of controller and host read operations, where the controller has a faster read speed than the host, e.g., 30 ns vs. 50 ns. The sub-page portions 420 are read by the controller and the sub-page portions 430 are read by the host. Since the controller reads faster than the host, the host can begin reading once one sub-page portion has been stored in the buffer, similar to the approach of FIG. 4a. At 0-50 ns, sub-page A is pre-read by the controller and stored in the buffer. The READY signal is set at 50 ns, as in FIG. 4a. The read process is completed once the host finishes reading portion H at 610 ns.

Specifically, while the host reads portion A from the buffer at 50-120 ns, the controller reads portion B at 50-100 ns and part of portion C at 100-120 ns. Likewise, while the host reads portion B at 120-190 ns, the controller reads part of portion C at 120-150 ns and part of portion D at 150-190 ns. While the host reads portion C at 190-260 ns, the controller reads part of portion D at 190-200 ns, part of portion E at 200-250 ns and part of portion F at 250-260 ns. While the host reads portion D at 260-330 ns, the controller reads part of portion F at 260-300 ns and part of portion G at 300-330 ns. While the host reads portion E at 330-400 ns, the controller reads part of portion G at 330-350 ns and portion H at 350-400 ns.

FIG. 4c depicts timing of controller and host read operations, where the host has a faster read speed than the controller, e.g., 30 ns vs. 50 ns. The setting of the READY signal tends to be more problematic in this situation as there is a greater risk that the buffer will run out of data before a complete page has been read by the host if the READY signal is set too soon. The sub-page portions 440 are read by the controller and the sub-page portions 450 are read by the host. Since the host reads faster than the controller, the host must wait relatively longer before it can begin its burst read of the buffer. In this case, the portions A, B, C and D are pre-read by the controller, and the READY signal is set at 200 ns, so that a higher read latency is incurred. The read process is completed once the host finishes reading portion H at 440 ns.

Specifically, while the controller reads portion E from the buffer at 200-250 ns, the host reads portion A at 200-230 ns and part of portion B at 230-250 ns. While the controller reads portion F at 250-300 ns, the host reads part of portion B at 250-260 ns, part of portion C at 260-290 ns and part of portion D at 290-300 ns. While the controller reads portion G at 300-350 ns, the host reads part of portion D at 300-320 ns, and all of portion E at 320-350 ns. While the controller reads portion H at 350-400 ns, the host reads portion F at 350-380 ns and part of portion G at 380-400 ns. Finally, the host reads part of portion G at 400-410 ns and all of portion H at 410-440 ns.

A memory device may have a slower internal memory read speed than a host due to a number of factors such as an insufficient number of sense amplifiers, or a slow clock speed. In this case, instead of waiting for the full page to be read from the memory array by the controller before setting the READY signal, based on the read cycle time of the target applications of the host, the memory device can be trimmed such that the data is available for readout after a certain portion of the page is read from the memory. Each memory device can be trimmed separately. The remaining portion of the data within the page will continuously be read from the memory array by the controller while the host reads the data out of the device. There is no pre-defined sub-page or partition to synchronize the internal memory read and the external access. This scheme is essentially a race between the host read and the internal memory read. The trimming/adjustment can guarantee that the internal memory read will reach the end of the given page, e.g., storing the page in the buffer, before the host completes its burst read of the buffer.

The number of bits/bytes that are read out by the controller prior to the host access can be varied to accommodate the host read speed, achieving the maximum read bandwidth for the given system and memory read performance. Generally, in a system where the host cycle time is t_{H} and the memory device is capable of sensing and latching one byte of data in t_{M} (t_{M}>t_{H}) with page size of N bytes, the read latency (t_{R}) for page/burst-mode read can be customized such that after M bytes from the starting address are read from the memory, the host can start clocking out the data. M (or t_{M}) can be trimmed/adjusted based on target host speed such that the device can have any byte from the remaining (N-M) bytes ready when the host reaches the corresponding byte address. This allow the host start accessing the data earlier and leaves sufficient time for the device to read the remaining data before the host “catches up” to the internal read operation, providing a great improvement on page read latency, especially for larger page sizes and/or slower hosts.

Generally, the process for optimizing the system read bandwidth for a given system cycle time can be implemented by the following steps:

1) The host issues a page read command specifying starting byte address;

2) The memory device starts reading a pre-defined (trimmable) number of bytes from the memory array and latches them into a page buffer;

3) The device informs the host that the data is ready for access (even though only a portion of the page is read into the page buffer); and

4) The host clocks out the data while internally the device is still reading data out of memory array.

Moreover, the process can be utilized in different page organizations. Usually, the page is divided into “columns” which include multiple data bytes if there are not enough sense amplifiers to attach to every bit line. For example, NOR flash devices can perform a byte-by-byte read very fast, but there are not enough sense amps to supply a large amount of data such as a 2-4 Kb page. Since the memory array sensing is done on a column basis, the process can account for the fact that all the data bytes within the same column are sensed at the same time. Specific examples are provided below.

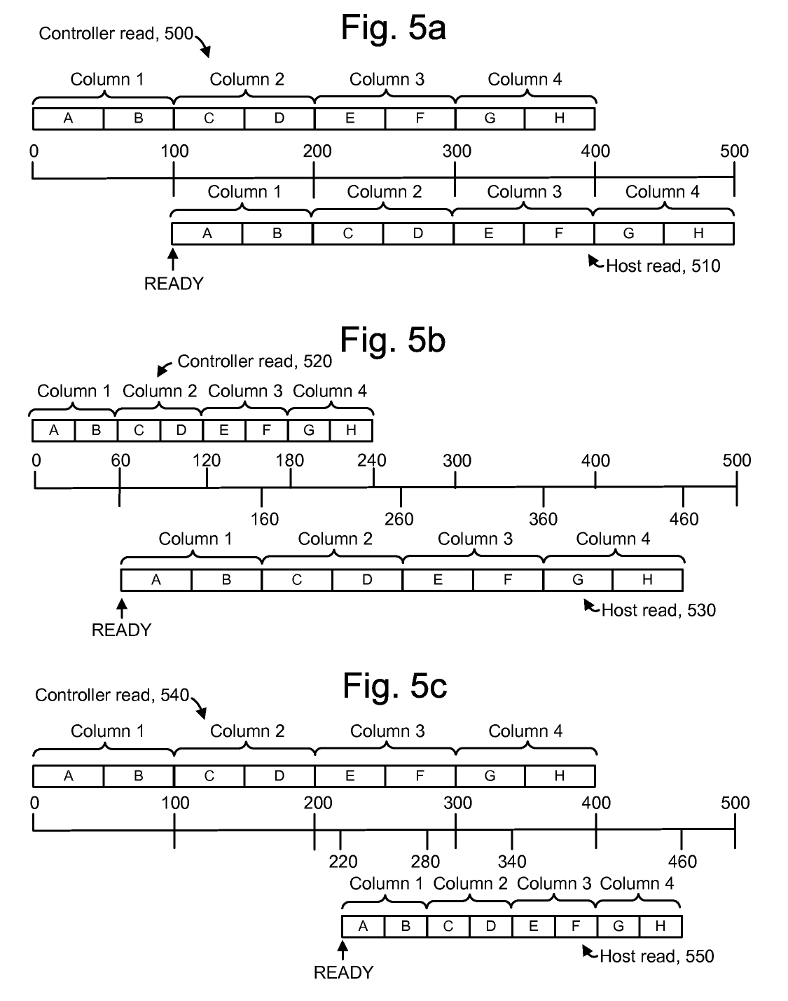

FIG. 5a depicts timing of controller and host read operations of page columns, where the controller and host have the same read speed. A page includes data portions labeled column 1, column 2, column 3 and column 4, which are each sub-pages. The data portions 500 are read by the controller while the data portions 510 are read by the host. For instance, each column may have two bytes of data, and there may be four columns in an eight byte page. Thus, column 1 has bytes A and B, column 2 has bytes C and D, column 3 has bytes E and F, and column 4 has bytes G and H. The controller and host read cycle time is 100 ns, in which two bytes are read. At 0-100 ns, column 1 is pre-read by the controller and stored in the buffer. The READY signal is set at 100 ns at which time the host begins reading column 1, denoting the read latency. At 200 ns, the controller has completed reading, and the host begins reading, column 2. At 300 ns, the controller has completed reading, and the host begins reading, column 3. At 400 ns, the controller has completed reading, and the host begins reading, column 4. The read process is completed at 500 ns once the host finishes reading column 4.

Here, only one cycle of pre-read is needed and the flow can easily accommodate different page organization and/or number of sense amplifiers as it is adjustable based on external (host) as well as internal memory organization and data path.

FIG. 5b depicts timing of controller and host read operations of page columns, where the controller has a faster read speed than the host. The data portions 520 are read by the controller, with a read cycle time of e.g., 60 ns, while the data portions 530 are read by the host, with a read cycle time of, e.g., 100 ns.

At 0-60 ns, column 1 is pre-read by the controller and stored in the buffer. The READY signal is set at 60 ns. The read process is completed once the host finishes reading portion H at 460 ns. Specifically, while the host reads column 1 from the buffer at 60-160 ns, the controller reads column 2 at 60-120 ns and part of column 3 at 120-160 ns. Likewise, while the host reads column 2 at 160-260 ns, the controller reads part of column 3 at 160-180 ns and all of column 4 at 180-240 ns. The controller has now completed reading, but the host reads column 3 at 260-360 ns and column 4 at 360-460 ns.

FIG. 5c depicts timing of controller and host read operations of page columns, where the host has a faster read speed than the controller. The data portions 540 are read by the controller, with a read cycle time of e.g., 100 ns, while the data portions 550 are read by the host, with a read cycle time of, e.g., 60 ns.

At 0-220 ns, column 1, column 2 and part of column 3 are pre-read by the controller and stored in the buffer. The READY signal is set at 220 ns, denoting the read latency. The read process is completed once the host finishes reading portion H at 460 ns. Specifically, while the host reads column 1 from the buffer at 220-280 ns, the controller reads part of column 3. Likewise, while the host reads column 2 at 280-340 ns, the controller reads the remainder of column 3 at 280-300 ns and part of column 4 at 300-340 ns. While the host reads column 3 at 340-400 ns, the controller reads the remainder of column 4. Finally, the host reads column 4 at 400-460 ns.

Note that the host begins reading column 1 while the controller is reading column 3. Thus, the host can begin reading at a time when the controller is partway through reading a given sub-page or equivalently, partway through reading a given page. The host can but does not have to, wait for the controller to be at a beginning of a sub-page or page to begin reading from the buffer.

To generalize, a memory device has page size of N bytes (N×8 bits) with Q sense amplifiers available for data sensing, where Q<(N×8). A page buffer of N bytes is used to store the data read from the memory array. To initiate the page read access, the host issues a page read command followed by the starting byte address. Once the command and address information are confirmed by the memory device, M bytes of data from the selected page will be pre-read into the page buffer at the cycle time of t_{M} per byte, after which the READY signal is set and the host can start clocking the data out sequentially without the need to wait for the full page to be read from the memory. The read latency (t_{R}) is the time which the memory device requires to read the M bytes, where M<N. While the host is reading the data out of the memory device, the device is still sensing and latching the remaining (N-M) bytes sequentially into the page buffer until the end of the page is reached. The number of bytes read initially is adjustable based on the host cycle time (t_{H}) and internal read speed to maximize the system read bandwidth. M is chosen such that when the host reaches any of the remaining (N-M) bytes (in the sequential manner), the data is valid for readout, as described in the previous examples.

The sustained system read bandwidth is defined as N/(N×t_{H}+t_{R}) where t_{R}=M×t_{M}, resulting in the bandwidth of N/(N×t_{H}+M×t_{M}). In the example of FIG. 4c, t_{M}=50 ns per byte, N=8 bytes, M=4 bytes, t_{R}=200 ns, and t_{H}=30 ns. Thus, the bandwidth is 8/(8×30+200)=8/440 bytes/ns. In a system where t_{M}>t_{H}, i.e., the internal memory read speed is slower, this design can increase t_{R} to a minimum time required (M×t_{M}). On the other hand, if a system has t_{H}>t_{M}, the system read bandwidth is fully dominated by t_{H} as M can be as small as one byte. This process is fully adjustable such that the memory device can be trimmed to maximize the system performance.

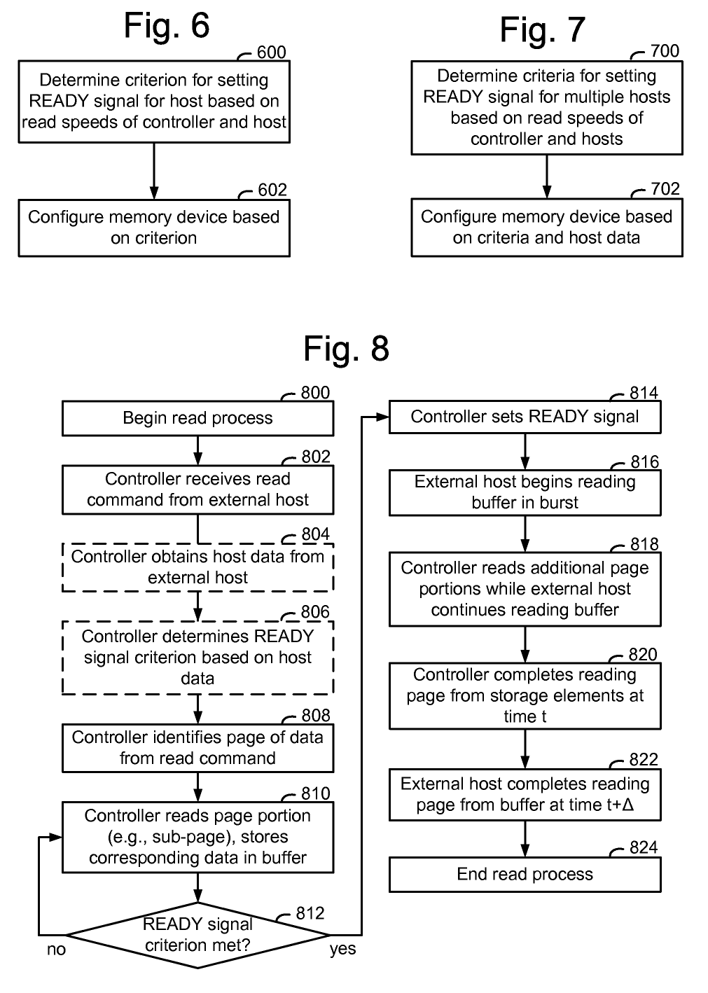

FIG. 6 depicts a process for configuring a memory device for read operations with a host. Using the techniques discussed herein, an optimum time for initiating an external host read can be determined based on the read speeds of a controller and the host. Thus, step 600 of the process includes determining at least one criterion for setting the READY signal based on the read speeds of a controller and a host. For example, the at least one criterion can be set to minimize a delay between when the storing of data in the buffer is completed and when the external host finishes reading the buffer. The at least one criterion can be set based on the host having a faster read rate than the controller, the host having a slower read rate than the controller, or the host having the same read rate as the controller. The at least one criterion can include an amount of data (e.g., number of bytes) which must be read from a set of storage elements and stored in a buffer before the buffer is ready to be read by the external host. The at least one criterion can include an amount of time which must pass once reading of a set of storage elements is started before the buffer is ready to be read by the external host.

Step 602 includes configuring the memory device based on the criterion. For example, this can include storing the criterion in a non-volatile storage location in the memory device. For instance, when the criterion is an amount of data for the controller to read before the READY signal can be set, the amount of data can be stored in the logic of the memory device, such as in a state machine. The data can then be accessed by the state machine during operation of the memory device. The criterion can also be hard coded into the memory device, such as in a ROM fuse. The memory device can be configured using any known techniques so that the memory device can use the criterion to determine a desired time at which the host begins to read.

FIG. 7 depicts a process for configuring a memory device for read operations with multiple hosts. A given memory device may be configured to operate with different hosts having different read speeds, or with a single host having different read speeds. For instance, a memory device may be used with different host devices. The memory device may be designed to be easily inserted into, and removed from, the host device, such as when the memory device is a memory card, or the memory device may be more permanently installed into the host device. Also, a given host may have the capability to operate at different speeds, such as when it has multiple processors or a processor which operates at different clock speeds.

In such cases, step 700 of the process includes determining criteria for setting the READY signal for multiple hosts (or of one host having different read speeds) based on the read speeds of the controller and each of the hosts. The criteria can be set, e.g., as discussed in connection with FIG. 6 for each combination of controller read speed (read cycle time) and host read speed. Step 702 includes configuring the memory device based on the criteria and host data. For instance, each host's data can include an associated identifier, e.g., as a data string, which it communicates to the memory device. This communication can take place each time the host device is powered on, for instance, or when the host issues a read command to the memory device. The host may communicate the data based on a prompting from the memory device, or based on its own determination of when to communicate.

The memory device then uses the host data to cross reference to a READY signal criterion. For example, the memory device may cross reference, e.g., using a look up table or other technique, identifier “host1” to a criterion “4 bytes” or “200 ns” indicating that the READY signal should be set once the controller reads four bytes of data from the storage elements or once 200 ns has passed after the controller has started reading. Similarly, the memory device may cross reference identifier “host2” to a criterion “2 bytes” or “100 ns” indicating that the READY signal should be set once the controller reads two bytes of data from the storage elements or once 100 ns has passed after the controller has started reading. For example, the memory device can be pre-configured, e.g., at the time of manufacture, with data which correlates host identifiers with criterion for setting the READY signal. A host which operates at different read speeds can have a different identifier for each read speed.

The memory device controller may also operate at different read speeds, in which case a READY signal criterion is provided for each internal read speed and each of one more host read speeds.

The criterion can be stored in a non-volatile storage location of the memory device, hard coded into the memory device, or otherwise configured into the memory device.

In another option, the host data communicated to the memory device is the host's read speed, which is used by the memory device to cross reference to a READY signal criterion. For example, the memory device may cross reference a host read speed of “30 ns” to a criterion “4 bytes,” indicating that the READY signal should be set once the controller reads four bytes of data from the storage elements. This corresponds to the example of FIG. 4c, assuming a memory device controller speed of 50 ns. Similarly, the memory device may cross reference a host read speed of “50 ns” to a criterion “1 byte.” This corresponds to the example of FIG. 4b, assuming a memory device controller speed of 30 ns.

In another option, the host is configured with the criterion for setting the READY signal and communicates it to the memory device. The host may be pre-configured with the criterion based on knowledge of the type of memory device which will be used with the host, or the memory device may communicate data such as its read speed or a memory device identifier which the host cross references to the criterion, and communicates the criterion back to the memory device for use by the memory device in setting the READY signal. The memory device may communicate the data based on a prompting from the host, or based on its own determination of when to communicate with the host. For example, the memory device may communicate its read speed of “50 ns” to the host, which cross references the read speed to a criterion “4 bytes,” indicating that the READY signal should be set once the controller of the memory device reads four bytes of data from the storage elements. The host then communicates the result of “4 bytes” to the memory device.

Various other options are possible for implementing an optimal read process based on capabilities of a host and a memory device controller.

FIG. 8 depicts a read operation. Note that the steps indicated are not necessarily performed as discrete steps. Step 800 includes beginning a read process. Step 802 includes the memory device controller receiving a read command from an external host. When used, step 804 includes obtaining host data from the external host and step 806 includes the controller determining the READY signal criterion based on the host data. At step 808, the controller identifies one or more pages of data from the read command. Note that when multiple pages are read, the process proceeds one page at a time as discussed herein. At step 810, the controller reads a page portion, e.g., sub-page, and stores the corresponding data in a buffer of the memory device. At decision step 812, if the READY signal criterion has not yet been met, the controller reads another sub-page at step 810. This cycle is repeated until the READY signal criterion is met at decision step 812. For example, the criterion may be to read four sub-pages (e.g., four bytes) before setting the READY signal, as depicted in FIG. 4c. The cycle at steps 810 and 812 is thus performed four times until the forth byte is read internally.

Once the criterion is met, step 814 includes the controller setting the READY signal. For instance, the external host may monitor a bus on which the READY signal is set to learn of it being set. Step 816 includes the external host beginning to read units of data from the buffer in a burst. The units of data can differ in size from the portions of data in the buffer. Step 818 includes the controller reading additional pages portions while the external host continues to read the buffer. Step 820 includes the controller completing reading the page from the storage elements at a time “t.” Note that the host read is not synchronized with the internal controller read; that is, the host read is asynchronous to the internal controller read. Step 822 includes the external host completing reading the page from the buffer at time t+Δ. For example, in FIG. 4c, t=400 ns and Δ=40 ns. A goal of the read process provided herein is to minimize the delay Δ while allowing a burst read. The read process ends at 824 for a given page. Thus, the host finishes reading the buffer no sooner than when the storing of data from each sub-page in the buffer by the controller is completed. An additional page can be read by repeating the process starting at step 802.

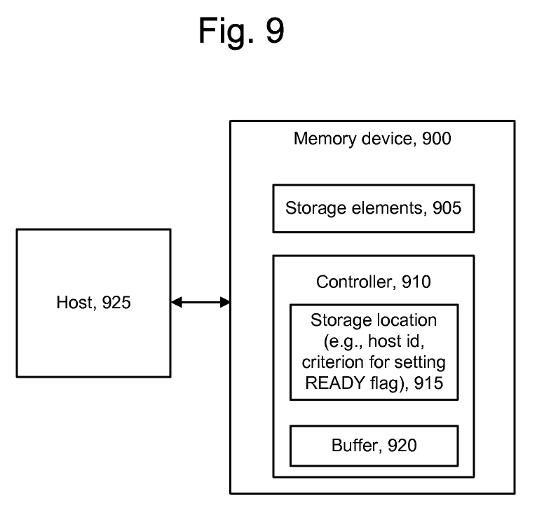

FIG. 9 depicts an overview of a host controller and a memory device in a storage system. The memory device alone may also be considered to be a storage system. Storage elements 905 can be provided in a memory device 900 which has its own controller 910 for performing operations such as programming and reading. The memory device may be formed on a removable memory card or USB flash drive, for instance, which is inserted into a host device such as a laptop computer, digital camera, personal digital assistant (PDA), digital audio player, mobile phone, digital video recorder (DVR) and portable DVD player.

The host device 925 may have its own controller for interacting with the memory device, such as to read or write user data. For example, when reading data, the host 925 can send commands to the memory device indicating an address of user data to be retrieved. The memory device controller converts such commands into command signals that can be interpreted and executed by control circuitry in the memory device. The controller 910 may also contain a storage location 915 for storing information such as host identifiers or other host data cross referenced to criterion for setting a READY flag. Such information can also be hard coded into the memory device, as mentioned. A buffer memory 920 is provided for temporarily storing user data being written to or read from the memory array.

The memory device responds to a read command by reading the data from the storage elements and making it available to the host controller. In one possible approach, the memory device stores the read data in the buffer 920 and informs the host 925 of when the data can be read. The host responds by reading the data from the buffer and sends another command to the memory device to read data from another address. For example the data may be read page by page.

A typical memory system includes an integrated circuit chip that includes the controller 910, and one or more integrated circuit chips that each contains a memory array and associated control, input/output and state machine circuits. The memory device may be embedded as part of the host system, or may be included in a memory card that is removably insertable into a mating socket of a host system. Such a card may include the entire memory device, or the controller and memory array, with associated peripheral circuits, may be provided in separate cards.

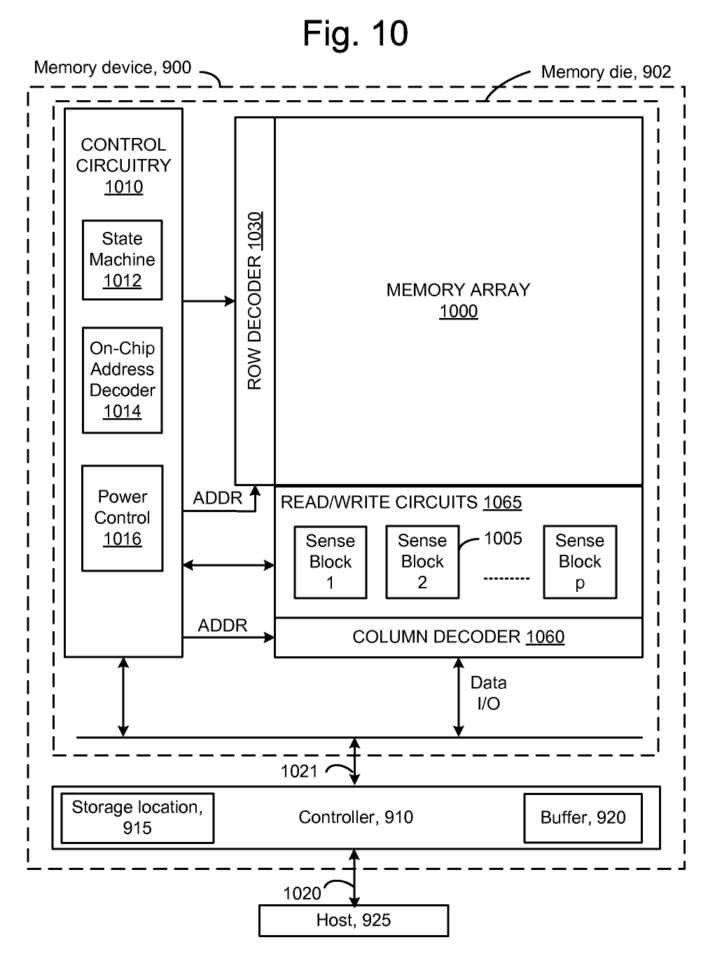

FIG. 10 is a block diagram of a non-volatile memory system using single row/column decoders and read/write circuits. The diagram illustrates the memory device 900 of FIG. 9 having read/write circuits for reading and programming a page of storage elements. Memory device 900 may include one or more memory die 902. Memory die 902 includes a two-dimensional array of storage elements 1000, control circuitry 1010, and read/write circuits 1065. In some embodiments, the array of storage elements can be three dimensional. The memory array 1000 is addressable by word lines via a row decoder 1030 and by bit lines via a column decoder 1060. The read/write circuits 1065 include multiple sense blocks. Typically, the controller 910 is included in the same memory device 900 (e.g., a removable storage card) as the one or more memory die 902. Commands and data are transferred between the host 925 and the controller 910 via lines 1020 and between the controller and the one or more memory die 902 via lines 1021.

The control circuitry 1010 cooperates with the read/write circuits 1065 to perform memory operations on the memory array 1000. The control circuitry 1010 includes a state machine 1012, an on-chip address decoder 1014 and a power control module 1016. The state machine 1012 provides chip-level control of memory operations. For example, the state machine may be configured to perform the read operations discussed herein. Note that a micro controller could optionally be used as opposed to a fixed state machine. The on-chip address decoder 1014 provides an address interface between that used by the host or a memory controller to the hardware address used by the decoders 1030 and 1060. The power control module 1016 controls the power and voltages supplied to the word lines and bit lines during memory operations. For example, the power control module 1016 can provide a control gate read voltage to a selected word line, and read pass voltages to unselected word lines, for use during read operations. The power control module 1016 may include one or more digital-to-analog converters, for instance.

In some implementations, some of the components of FIG. 10 can be combined. In various designs, one or more of the components (alone or in combination), other than storage element array 1000, can be thought of as a managing or control circuit. For example, one or more managing or control circuits may include any one of, or a combination of, control circuitry 1010, state machine 1012, decoders 1014/1060, power control 1016, sense blocks 1005, read/write circuits 1065, controller 910, host 925, and so forth.

The data stored in the memory array is read out by the column decoder 1060 and output to external I/O lines via the data I/O line and the data input/output buffer 920. Program data to be stored in the memory array is input to the data input/output buffer 920 via the external I/O lines. Command data for controlling the memory device are input to the controller 1050. The command data informs the flash memory of what operation is requested. The input command is transferred to the control circuitry 1010. The state machine 1012 can output a status of the memory device such as READY/BUSY or PASS/FAIL. When the memory device is busy, it cannot receive new read or write commands.

The data storage location 915 may also be provided in connection with the controller 910.

In another possible configuration, a non-volatile memory system can use dual row/column decoders and read/write circuits. In this case, access to the memory array by the various peripheral circuits is implemented in a symmetric fashion, on opposite sides of the array, so that the densities of access lines and circuitry on each side are reduced by half.

The foregoing detailed description of the invention has been presented for purposes of illustration and description. It is not intended to be exhaustive or to limit the invention to the precise form disclosed. Many modifications and variations are possible in light of the above teaching. The described embodiments were chosen to best explain the principles of the invention and its practical application, to thereby enable others skilled in the art to best utilize the invention in various embodiments and with various modifications as are suited to the particular use contemplated. It is intended that the scope of the invention be defined by the claims appended hereto.

What is claimed is:

1. A method for operating a memory device, comprising:
in response to a read command from an external host, successively reading portions of a set of storage elements, one portion at a time, and storing data from each portion in a buffer;
determining when the buffer is ready to be read by the external host based on at least one criterion; and
when the buffer is ready to be read based on the determining, informing the external host that the buffer is ready to be read, in response to which the external host starts reading the buffer in a burst, asynchronous to the storing of data from each portion in the buffer, and finishes reading the buffer no sooner than when the storing of data from each portion in the buffer is completed.

2. The method of claim 1, wherein:
the successively reading starts partway through a page of data.

3. The method of claim 1, wherein:
the successively reading starts at a beginning of a page of data.

4. The method of claim 1, wherein:
the portions have different sizes.

5. The method of claim 1, wherein:
the external host reads units of data from the buffer which different in size from the portions.

6. The method of claim 1, wherein:
each storage element is in communication with a respective bit line, and the portions are read via the respective bit lines and a set of sense amplifiers, where there are fewer sense amplifiers than bit lines.

7. The method of claim 1, wherein:
the at least one criterion is set to minimize a delay between when the storing of data in the buffer is completed and when the external host finishes reading the buffer.

8. The method of claim 1, wherein:
the at least one criterion is set based on a first rate at which the reading of the portions and the storing of data from each portion in the buffer occurs, and a second rate at which the reading of the buffer by the external host occurs, the second rate is faster than the first rate.

9. The method of claim 1, wherein:
the at least one criterion is set based on a first rate at which the reading of the portions and the storing of data from each portion in the buffer occurs, and a second rate at which the reading of the buffer by the external host occurs, the second rate is slower than the first rate.

10. The method of claim 1, wherein:
the at least one criterion is set based on a first rate at which the reading of the portions occurs, the storing of data from each portion in the buffer occurs, and the reading of the buffer by the external host occurs.

11. The method of claim 1, wherein:
the at least one criterion comprises an amount of data which must be read from the set and stored in the buffer before the buffer is ready to be read by the external host.

12. The method of claim 1, wherein:
the at least one criterion comprises an amount of time which must pass once reading of the set is started before the buffer is ready to be read by the external host.

13. The method of claim 1, wherein:
the set of storage elements is on a memory die, and the determining when the buffer is ready to be read by the external host comprises accessing data from a location on the memory die.

14. The method of claim 1, further comprising:
receiving data from the external host, the determining when the buffer is ready to be read by the external host is responsive to the data.

15. The method of claim 1, wherein:
the successively reading portions includes decoding the portions using error correction code decoding.

16. The method of claim 1, wherein:
the successively reading portions includes decoding the portions using redundancy code decoding.

17. A method for operating a memory device, comprising:
receiving a read command from an external host;
in response to the read command, successively reading portions of a set of storage elements, one portion at a time, and storing data from each portion in a buffer;
receiving host data from the external host;
determining when the buffer is ready to be read by the external host based on the host data; and
when the buffer is ready to be read based on the determining, informing the external host that the buffer is ready to be read.

18. The method of claim 17, wherein:
in response to the informing the external host that the buffer is ready to be read, the external host starts reading the buffer in a burst, asynchronous to the storing of data from each portion in the buffer, and finishes reading the buffer no sooner than when the storing of data from each portion in the buffer is completed.

19. The method of claim 17, wherein:
the external host reads units of data from the buffer which different in size from the portions.

20. The method of claim 17, wherein:
the host data identifies a type of the host.

21. The method of claim 17, wherein:
the host data identifies a read cycle time of the host.

22. A method for operating a memory device, comprising:
determining a criterion by which the memory device signals an external host to begin continuously reading data from a buffer in the memory device, such that the external host finishes reading the buffer no sooner than when a page of data is completely stored in the buffer from storage elements of the memory device, the page of data is stored in the buffer one sub-page at a time, asynchronous with, and at a slower rate than, the reading of the data from the buffer by the external host; and
configuring the memory device with the criterion.

23. The method of claim 22, wherein:
the criterion minimizes a delay between when the page of data is completely stored in the buffer and when the external host finishes reading the buffer.

24. The method of claim 22, wherein:
the criterion comprises at least one of an amount of data which must be stored in the buffer and an amount of time which must pass, before the memory device signals the external host to begin continuously reading data from the buffer.

25. The method of claim 22, wherein:
the configuring comprises storing the data which identifies the criterion in a non-volatile storage location in the memory device.
